(19) United States
(12) Patent Application Publication
(10) Pub. No.: US 2008/0285389 A1
(43) Pub. Date: Nov. 20, 2008

(54) Electronic Message Calendar

(76) Inventors: Robert F. Borovsky, Bradenton, FL (US); John P. Downs, Colgate, WI (US); Patrick A. Downs, Milwaukee, WI (US); Burton J. Peterson, Waterford, WI (US)

Correspondence Address: BOYLE FREDRICKSON S.C., 840 North Plankinton Avenue, MILWAUKEE, WI, 53203, US

(21) Appl. No.: 11/912,235

(22) PCT Filed: Apr. 19, 2006
(86) PCT No.: PCT/US06/14787

§ 371 Date: Jun. 9, 2008

Related U.S. Application Data
(60) Provisional application No. 60/674,078, filed on Apr. 22, 2005.

(51) Int. Cl. G04B 19/24; G04B 47/00

(52) U.S. Cl. 368/10; 368/28

(57) ABSTRACT

An electronic calendar provides a large area switch array with multiple dedicated date entry buttons and multiple date entry modes to substantially reduce operator access time. Lightweight low profile circuitry allows the calendar to be easily attached by a consumer to the front of a refrigerator or the like and audio messaging eliminates time-consuming handwritten entries.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

The present invention relates generally to appointment calendars and particularly to electronic calendars providing appointment storage in computer memory.

Individuals and families often keep track of their schedules using a paper appointment calendar located in a convenient location. Paper calendars are intuitive, simple to use, and low in cost. Nevertheless, such calendars typically provide only a limited writing space for each day which can be quickly exhausted with multiple coincident appointments. Further, entering written appointments on the calendar can be inconvenient, especially when the calendar is mounted on a vertical surface. Finally, practical paper calendars are also necessarily limited to a short time period, typically a year, making the scheduling of annual appointments or appointments near the end of the calendar year difficult.

Computerized appointment calendars, such as those incorporated into personal digital assistants (PDA's), have been developed that overcome some of these deficiencies. Such calendars flexibly allocate appointment space as needed in an electronic solid-state memory and thereby can provide multi-year time spans with arbitrary numbers of messages per day. The most common of these systems allow a text message to be entered and assigned to a date that may be recalled in calendar-like fashion or which may produce an alarm at a predetermined time. Some systems allow storage of audio messages.

Despite some advantages, PDA-type appointment calendars are at a disadvantage over a standard paper calendar for quickly recording an individual appointment, or reviewing current appointments at a glance and work best when the user already has the device activated for another purpose or where portability is more important than convenience. Perhaps for this reason, most households continue to rely on a paper calendar posted in a convenient location for recording appointments and important dates.

### BRIEF SUMMARY OF THE INVENTION

The present invention provides an electronic calendar system designed to match a paper calendar in convenience of entry and review of appointments while providing the advantages of a computerized data storage. Appointment content is entered by digitally recording the user's voice message, while an appointment date is entered using a “rich set” of dedicated date buttons eliminating time-consuming menus and sequential date selection steps. In a preferred embodiment, the rich set of date buttons allow a date to be rapidly invoked in any of three different ways including through a “today” button, a day-of-the-week button, or standard calendar-like date and month buttons. Audio entry capabilities eliminate the burden of handwriting and make it convenient to mount the calendar on a vertical surface. A single dedicated function and solid state circuitry for recording, storage and playback allows the calendar to be instantaneously available without “boot-up” time and for the calendar to be powered using only battery power for periods as long as a year. Battery power, in turn, allows the calendar to be conveniently located at a central location, for example, on the door of a household refrigerator, further rivaling the convenience of a paper calendar.

Specifically, the present invention provides an electronic calendar system having a microphone accepting audio messages from an operator, a date entry system accepting entry of a message date from the operator, and a speaker. A computer system communicates with the microphone, date entry system and speaker and executes a stored program to link an audio message from the microphone to a message date from the date entry system and to play back the audio message linked to the message date upon invocation of the message date. The date entry system may provide at least one button dedicated to the entry of each of the current day (today), day of the current week referenced to the current day, and month and days of the month.

Thus, it is one object of at least one embodiment of the invention to provide an electronic calendar that rivals a paper calendar for convenience of entry or recall of appointments while providing advantages in storage capacity and versatility beyond that provided by a paper calendar.

The switch array may provide at least thirty-one switches for each day of the month, twelve switches for each month of the year, and seven switches for the days of the current week.

Thus, it is an object of at least one embodiment of the invention to provide both a simple, intuitive date entry system that minimizes button presses for common date selection tasks.

The switch array may be a membrane switch panel providing a plurality of normally open switches on a continuous laminated membrane.

Thus, it is another object of at least one embodiment of the invention to provide a practical, low-cost and lightweight implementation of the switch array of the present invention.

The switch array may include a playback button and the computer may further execute the stored program to monitor a current date, and the invocation of a message date may be the current date and an activation by the operator of the playback button.

Thus, it is an object of at least one embodiment of the invention to reduce to a single button press, the most common access mode of checking today's appointments.

The playback button may be a switch dedicated to the entry of a current day.

Thus, it is another object of at least one embodiment of the invention to further simplify the interface by allowing a single prominent “today” button to function both to record or invoke messages.

The invocation of a date may be a date entered through the switch array.

Thus, it is another object of at least one embodiment of the invention to allow flexible selection of days other than the current day for message playback or entry.

The switches may be clustered in separated groups representing each of the current day, days of the current week referenced to the current day, and months and days of the month.

Thus, it is another object of at least one embodiment of the invention to minimize the time it takes the operator to identify the necessary date entry buttons by spatial grouping of the buttons according to date entry method.

The computer may execute the stored program to provide voice descriptions of the date functions of activated switches of the switch array selected from the group consisting of day of the week, month, and day of the month.

Thus, it is an object of at least one embodiment of the invention to provide rapid feedback to the user of the date entry made by the user without the need for a separate visual display.

The computer may preface a played-back audio message with the day of the week, the month, and the day of the month only when the day of the week, the month, and the day of the month was not provided in the voice descriptions of the activated switches.

Thus, it is an object of at least one embodiment of the invention to further minimize the time required for the user to access or record a message.

The switch array may further include a to-do button and the computer system may link an audio message from the microphone to a to-do list and play back the audio messages so linked regardless of the current date upon pressing the to-do button.

Thus, it is another object of at least one embodiment of the invention to provide a dateless to-do list.

The computer system may link a first and second audio message to a single message date and play back each of the audio messages linked to the message date upon invocation of the message date.

It is thus another object of at least one embodiment of the invention to allow multiple messages to be assigned to a given date.

The computer system may preserve audio messages having message dates earlier than the current date for a predetermined time and may play back audio messages linked to a first message date upon invocation of the first message date together with messages linked to a second message date in the predetermined time and having the same day of the week.

Thus, it is another object of at least one embodiment of the invention to resolve ambiguity in “day of the week” date entry allowing the user to review recently passed messages.

The calendar may include a visual display indicating that there is at least one audio message linked to a message date equal to the current date.

Thus, it is another object of at least one embodiment of the invention to eliminate a need for the consumer to invoke a date when there is no message available.

The day-of-the-month buttons may be arranged in rows and columns with number captions increasing from left to right and increasing top to bottom like a conventional calendar.

Thus, it is another object of at least one embodiment of the invention to provide intuitive date entry by employing a familiar calendar progression.

The switches used for the day of the week may encircle the switch dedicated to the current day.

Thus, it is another object of at least one embodiment of the invention to visually nest the different modes of date entry according to their relationship to the current day.

The electronic calendar system may have a housing supporting the microphone, the switch array, the speaker, the computer, and a battery power supply, and the housing may have at least one magnet attached to the rear surface of the housing for supporting the housing against a vertical metal refrigerator door.

Thus, it is another object of at least one embodiment of the invention to provide a calendar that can be readily attached to a fixture in the kitchen and central to most households for extremely ready access. The necessary lightweight and thin profile is enabled by the use of a membrane switch and integrated controller providing the computer and additional circuitry necessary for audio processing. Suitable battery life necessary for such a refrigerator mounting and data storage is facilitated by the use of a sleep mode processor and flash memory.

These particular objects and advantages may apply to only some embodiments falling within the claims and thus do not define the scope of the invention.

### BRIEF DESCRIPTION OF THE DRAWINGS

FIG. 1 is a perspective view of the calendar of present invention mounted on a front surface of a refrigerator for household use;

FIG. 2 is schematic diagram of the electrical components of the calendar, including a membrane switch array communicating with a micro controller and digital memory;

FIG. 3 is a front elevational view of the membrane switch array of FIG. 2;

FIG. 4 is a fragmentary rear perspective view of the housing of the calendar showing magnetic strips, support keyholes, and a folding easel providing alternative methods of supporting the calendar;

FIG. 5 is a state diagram showing the operation of a stored program of the microcontroller of FIG. 2 in responding to different date entry methods; and

FIG. 6 is a simplified representation of the computer memory showing access of the memory in different operating modes according to the program of the microcontroller.

### DETAILED DESCRIPTION OF THE PREFERRED EMBODIMENT

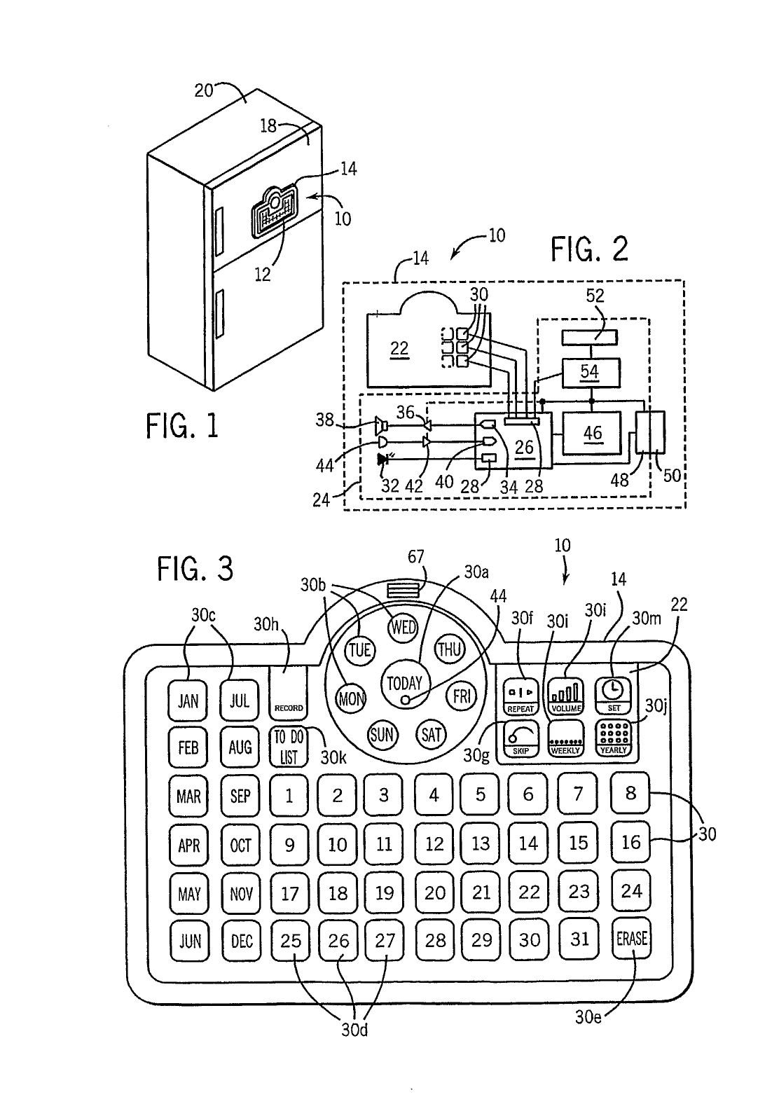

Referring now to FIG. 1, an electronic calendar 10 of the present invention may provide a planar switch array 12 exposed at a front surface of a housing 14, shown here, attached at a rear surface of the housing 14 to the ferromagnetic vertical face of a refrigerator door 18 of a refrigerator 20 so as to be readily accessible and visible to members of the household.

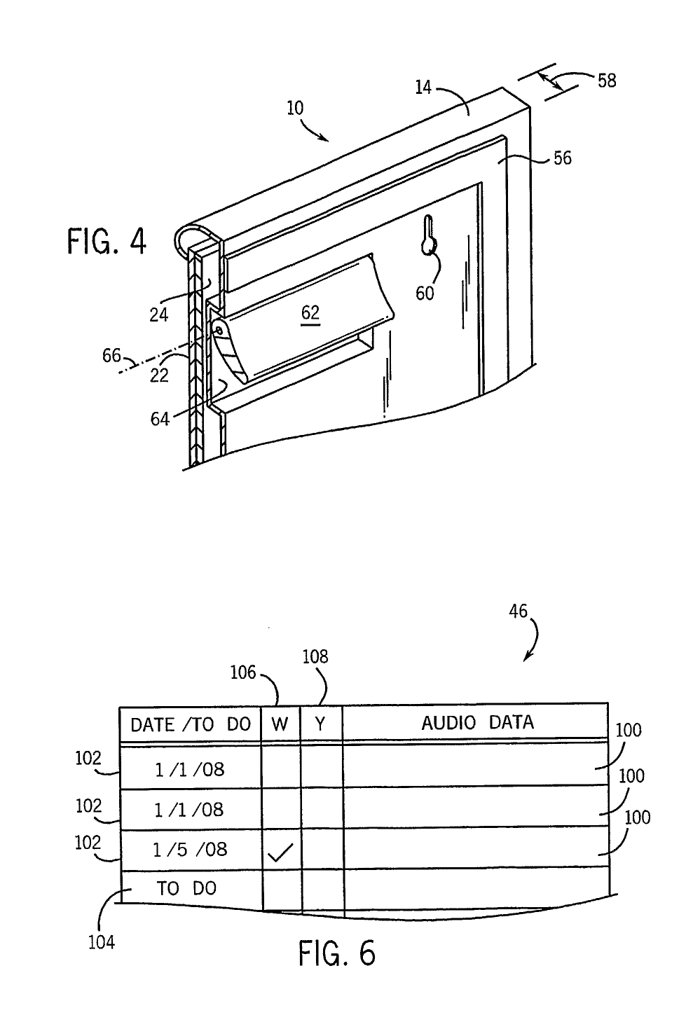

Referring now to FIGS. 2 and 4, the housing 14 may be a lightweight plastic frame surrounding a membrane switch 22 forming the switch array 12 and supported by a printed circuit board 24. The membrane switch 22 provides a lightweight and washable surface suitable for use in the household environment. While membrane switches are preferred, other switch types, such as discrete switches and touch screen panels may also be used.

The printed circuit board 24 supporting the membrane switch 22 may also hold a microcontroller 26 providing the essential components of a computer system and communicating with buttons 30 of the switch array 12, each providing a single pole, single throw, normally open switch through an integrated I/O port 28 providing binary input and output signals.

The I/O port 28 may also communicate with a light-emitting diode 32 providing a user display as will be described.

The microcontroller 26 further includes an integrated analog-to-digital converter 34 providing an audio signal to an amplifier 36 communicating with an audio speaker 38 held within the housing behind the membrane switch 22, and an analog-to-digital converter 40 receiving a signal from a buffer amplifier 42 communicating with a microphone 44 also held within the housing 14.

Thus, the micro controller 26 may read the state of each of the buttons 30 of the switch array 12, for example, using common row/column multiplexing techniques and may receive audio signals from microphone 44 in digital form and produce audio signals to speaker 38 by digital output. Microcontroller 26 may further include a clock circuit providing for the determining the current date as will be described.

Microcontroller 26 also communicates with an internal read-only memory and an external memory 46 attached to the printed circuit board 24. In the preferred embodiment, the external memory 46 is a flash memory capable of nonvolatile, random access storage of data including a stored program, pre-recorded audio messages providing date descriptions, and audio data entered by the user as appointment content from microphone 44 as will be described. Generally, any form of random access computer memory can be used including static random access memory with battery back-up, micro disk drives and the like.

Microcontroller 26 may optionally further communicate with a memory card socket 48 for receiving pre-loaded memory cards 50 containing additional program and/or additional audio data.

The housing 14 further provides a support for batteries 52 communicating through power conditioning circuitry 54 of a type well known in the art to provide power to the microcontroller 26, the external memory 46, and the preloaded memory card 50 (if any) without the need for connections between the electronic calendar and a power line.

Referring to FIG. 4, the rear of the housing 14 may include a peripheral frame of magnet strips 56 allowing the rear face of the housing 14 to be attached to a metal panel such as the door 18 of the refrigerator as shown in FIG. 1. For this purpose, the thickness 58 of the housing 14 is limited less than approximately 2 inches so as to provide a low profile to the housing that better avoids being dislodged by accidental contact by persons walking past a refrigerator or the like. The light weight of the membrane switch 22 and circuitry allows the magnet strips 56 to securely attach the electronic calendar 10 to a refrigerator door.

Alternative mountings of the housing 14 are provided by keyhole slots 60 in the rear surface of the housing 14 allowing the mounting the housing 14 on a wall with appropriate fasteners and a fold-out easel 62 allowing the housing 14 to be placed with its front surface upward on a horizontal surface, the front surface tipped slightly forward for better viewing. Rubber feet (not shown) may be added to the rear surface to stabilize the unit in this orientation. The easel 62 may pivot about a horizontal axis 66 into a recess 64 in the rear face of the housing 14 when not in use for shipping and/or installation of the electronic calendar 10 against a wall or other vertical surface.

Referring now to FIG. 3, the front of the housing 14 visually frames the switch array 12 of the electronic calendar 10. An upper portion of the frame of the housing 14 may include slots 67 providing an aperture for allowing sound to be received by the microphone 44 while the audio speaker 38 may transmit sound directly through the thin material of the membrane switch 22.

The buttons 30 of the switch array 12 are grouped spatially according to three different date entry modes. Each of the buttons 30 provides a button outline printed on a graphics layer of the membrane switch and a dedicated caption indicating its date entry function.

A central and prominently located TODAY button 30a provides an input indicating the current day as tracked by the clock of the micro controller 26. The LED 39 may extend through the TODAY button so as to centralize the most used functions of the electronic calendar, that of determining whether there are current appointment messages to be played and playing those messages.

Surrounding the TODAY button 30a are DAYS-OF-THE-WEEK buttons 30b providing one button for each day of the week from Sunday to Saturday. In the preferred embodiment, the Sunday button is positioned about seven o'clock with respect to the TODAY button 30a, and the remaining buttons proceed in a clockwise fashion from Sunday to Saturday, providing a general continuous flow according to standard calendar conventions. The DAYS-OF-THE-WEEK buttons 30b provide a second date entry mode referenced to the current date but not limited to the current date as with the TODAY button 30a. Generally, as will be described, the DA YSOF-THE-WEEK buttons 30b are interpreted to be the current date or in the future with respect to the current date.

Below and to the left of the TODAY button 30a and DAYS-OF-THEWEEK buttons 30b, and thus further displaced from the TODAY button 30a, are MONTH buttons 30c and DAYS-OF-THE-MONTH buttons 30d. The DAYS-OF THE-MONTH buttons 30d are arranged in four rows and eight columns for compactness as opposed to the standard seven columns of a calendar but otherwise reflect standard paper calendar configuration. The numbers of the DA YS-OF-THEMONTH buttons 30d generally increase from left to right and in rows from top to bottom in standard calendar form and include thirty-one separate buttons representing all possible days of any given month.

The MONTH buttons 30c are arranged in two columns for compactness to the left of the DAYS-OF-THE-MONTH buttons 30d, with January to June from top to bottom in the first column and from July to December from top to bottom in the second column.

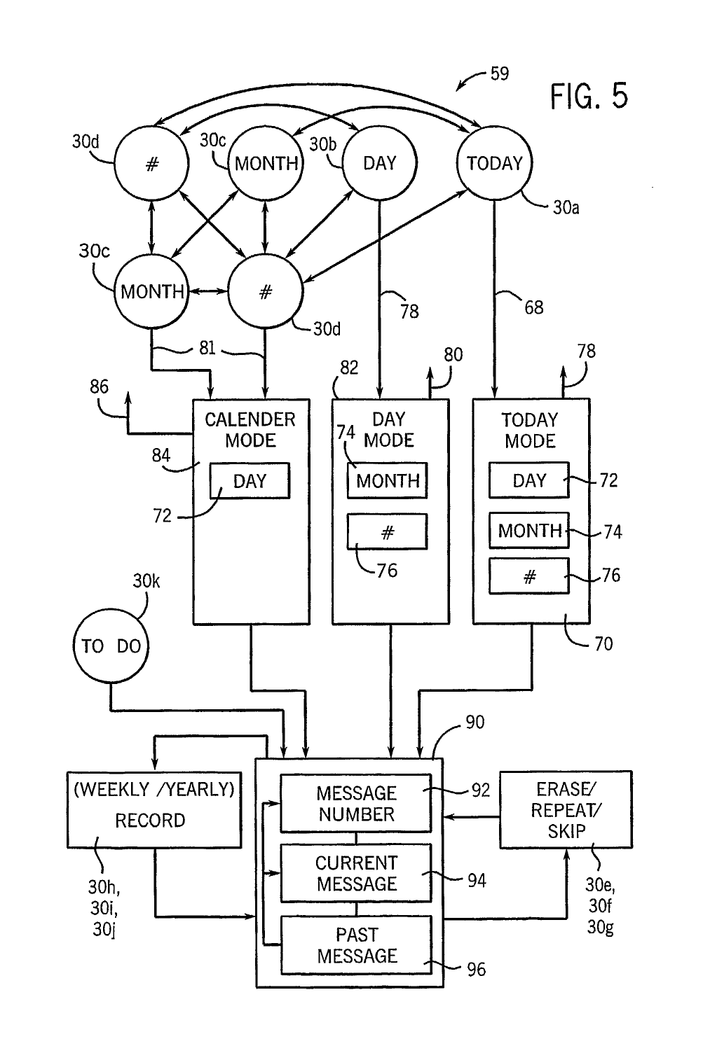

Referring now to FIGS. 3 and 5, a stored program 59 executed by the microcontroller 26, receives from the operator of the electronic calendar 10 pressing buttons 30 of the switch array 12, a message date. The message date may be used to play to the operator any stored audio messages related to that date or to allow the operator to record new audio messages to be linked to that message date in the computer memory.

The message date may be entered through anyone of three different paradigms. In the simplest paradigm, the message to be played or recorded is entered by means of the TODAY button 30a. Upon pressing of the TODAY button 30a, the word “Today” may be spoken by a message clip providing feedback of a pressing of the TODAY button 30a. The pressing of this button will further cause the computer to enter a TODAY mode 70, as indicated by arrow 68, in which the current day, month, and day of the month are announced by the microcontroller 26 using stored voice clips per speech states 72, 74, and 76, respectively. At any time during this announcing, the TODAY mode 70 may be exited as indicated by arrow 78 to return to anyone of the sets of buttons 30a through 30d whose pressing caused that interruption.

In a second mode of data entry, a DAYS-OF-THE-WEEK button 30b may be pressed causing the program to announce the day of the week corresponding to the pressed button 30b and then, per arrow 78, enter a DAY mode 82 in which the month and day of the month (but not current day of the week) are announced by the microcontroller 26 using stored voice clips per speech states 74 and 76, respectively. The DAY mode 82 may be interrupted at any time by the pressing of another button 30 per arrow 80.

In a third mode of date entry, a MONTH button 30c may be pressed followed by a DAY NUMBER button 30d indicating the day of the month, causing the microcontroller 26 to announce the day and month corresponding to the pressed buttons and to enter a CALENDAR mode 84, per arrows 81 which may be exited at any time as indicated by arrow 86. Conversely, the DAY NUMBER button 30d may first be pressed followed by the MONTH button 30c. In the CALENDAR mode 84, only the day is spoken per speech state 72.

Only the last sequence of interpretable button presses is used to determine whether the microcontroller 26 enters into the CALENDAR mode 84, DAY mode 82, or TODAY mode 70, respectively. Thus, the operator may press a DAY NUMBER button 30d followed by a MONTH button 30c, then followed by a DAY NUMBER button 30d resulting in the processor entering the DAY mode 82. Note that some of the transitional arrows have been eliminated for clarity. In the CALENDAR mode 84, DAY mode 82, or TODAY mode 70, only the information not previously announced is spoken, thus reducing the need for the operator to listen to redundant information such as may add a burden to the use of the electronic calendar 10.

Entry into one of the CALENDAR mode 84, DAY mode 82, or TODAY mode 70 states indicates that a unique date has been selected and the program 59, if there are no interruptions from other button pressings, moves automatically to a message retrieval mode 90. In that message retrieval mode 90, the computer memory (46 and/or 50) is searched for stored audio messages corresponding to the input message date. If there are no current messages, “No Messages” is played at a message number state 92. On the other hand, if there are stored messages, a message number will be announced per message number state 92 followed by any current stored message. This process is repeated with the message number increasing by one for each repetition until all messages are spoken.

Only if the message retrieval mode 90 has been entered from the CALENDAR mode 84, if the entered date is more than eleven month from the current date and less than 12 months from the current date, the entered date is assumed to be in the last thirty days. Thus if today is Mar. 30, 2005, and the entered day is March 12, it is assumed that the entered date is Mar. 12, 2005 for the purpose of message playback. For the purpose of entering a new message, the future date of Mar. 12, 2006 will be assumed. In this way it is possible to review past messages for the last thirty days.

At any time during a given message number state 92 and thus during the playing of a current message or past message, an erase button 30e, a repeat button 30f, or a skip button 30g may be pressed, causing the identified stored audio message to be erased, that is, to remove from memory permanently, to be repeated in its playback by repeating blocks 94, 96, or to be skipped by incrementing the message number of message number state 92.

Likewise, at any time during any message number state 92 including the playing of the message, a RECORD button 30h may be pressed and held to record a message associated with the invoked date. A simple pressing of the RECORD button 30h provides for a recording for as long as the button is held in a pressed state. The RECORD button 30h may be preceded by the pressing of a weekly button 30i or a yearly button 30j which will cause the recorded audio message to be stored in memory not only for the current date but for the same day of the week for the future for button 30i or every year on the same calendar day per button 30j.

A TO-DO LIST button 30k may also be provided that when invoked causes playing of special non-date linked “to-do” messages. A pressing of RECORD button 30h during or subsequent to the pressing of the TO-DO LIST button 30k will allow recording into a TO-DO LIST stored in memory, as described below. Weekly or yearly invocations are ignored in this mode.

After a pressing of the TO-DO LIST button 30k, one or more MONTH buttons 30c may be pressed. The message recorded will only be played back in the months so selected and will repeatedly show up for those months on a yearly basis until deleted.

Referring now to FIG. 6, the external memory 46 or memory card 50 may provide for the storage of operator-entered messages in a logical table form in which audio data 100 representing digitized audio messages is linked to date information 102 or the TO-DO LIST 104 (and optionally month data, not shown). When a date is invoked through the buttons 30 described with respect to FIG. 5, the table may be searched for matching date information 102 and the corresponding audio data 100 audio messages played. Alternatively, when the TO-DO LIST is invoked through the buttons 30, only audio data 100 associated with the TO-DO LIST 104 is played. Conversely, when the operator provides a recording of a new message, the date entered by the buttons 30 provides a new row entry in the logical table with the entered date being the date information 102 and the new message attached as the audio data 100. If weekly or yearly buttons 30i or 30j are used during recording, corresponding multiple date information 102 is entered pointing to a single entry of audio data 100 as will be understood to those of ordinary skill in the art.

The program 59 may further provide a background utility (not shown) as will be understood to those of ordinary skill in the art to switch the microcontroller 26 into a low-power consumption sleep mode to conserve battery life when no button pressing has occurred for a short interval. In this way, the batteries may last for as long as one year with ordinary use. In the sleep mode, the microcontroller 26 may periodically wake up to monitor the date and to activate the LED 32 if a message is available for that date as determined from the logical table. The power conditioning circuitry 54 may provide a low battery voltage signal to the microcontroller 26 causing it to indicate to the operator when a battery change is required, for example, by announcing “low battery” upon the next pressing of a button 30. The use of non-volatile memory ensures that critical appointment information is not lost when the batteries are changed.

The background utility may further manage certain memory housekeeping features, including the erasing of audio data 100 associated with a date entry 102 more than one month earlier from the current date. It follows that messages may be recalled through the CALENDAR mode 84 for up to one month after their date entry 102.

Referring again to FIG. 3, the program also provides system routines for setting the volume per volume using volume button 30l which may cycle through a limited set of volume presets, and for setting the calendar per button 30m and the calendar buttons 30d used both for date and time identification, the time allowing the electronic calendar 10 to know when dates roll over at midnight.

Referring again to FIG. 2, the voice captions provided in announcing the days and dates may be provided by stored audio clips in external memory 46 or internal read-on-memory of micro controller 26. Alternatively, custom voices, for example, using voices of celebrities, may be added through the addition of a memory card 50 attached to memory card socket 48. The memory may additionally have pre-loaded schedules, such as schedules of popular sporting teams or cultural events that may be automatically entered into the calendar by purchase of a memory card 50. Upgrading of the programs may also be provided in this manner.

It is specifically intended that the present invention not be limited to the embodiments and illustrations contained herein, but include modified forms of those embodiments including portions of the embodiments and combinations of elements of different embodiments as come within the scope of the following claims.

We claim:

1. An electronic calendar comprising:
a microphone accepting audio messages from an operator;
a date entry system accepting entry of a message date from the operator; a speaker;
a computer system communicating with the microphone, the date entry system and the speaker and executing a stored program to:
(i) link an audio message from the microphone to a message date from the date entry system in a computer memory;
(ii) play back of the audio message linked to the message date upon invocation of the message date;
wherein the date entry system is a switch array providing at least one switch dedicated to the entry of each of:
(i) the current day;
(ii) days of a current week referenced to the current day; and
(iii) months and days of the month.

2. The electronic calendar of claim 1 wherein the switch array provides at least thirty-one switches, one for each of thirty-one days of the month, for the switches dedicated to the entry of months and days of the month.

3. The electronic calendar of claim 1 wherein the switch array provides at least twelve switches, one for each of twelve months of the year, for the switches dedicated to the entry of months and days of the month.

4. The electronic calendar of claim 1 wherein the switch array provides at least seven switches, one for each of seven days of the week, for the switches dedicated to the entry of days of the current week.

5. The electronic calendar of claim 1 wherein the switch array is a membrane switch panel providing a plurality of normally open switches on continuous laminated membranes.

6. The electronic calendar of claim 1 wherein the switch array includes a playback button and wherein the computer further executes the stored program to monitor a current date and wherein the invocation is the current date and an activation by the operator of the playback button.

7. The electronic calendar of claim 6 wherein the playback button is the switch dedicated to the entry of the current day.

8. The electronic calendar of claim 1 wherein the invocation is a date entered through the switch array.

9. The electronic calendar of claim 1 wherein the switches are clustered in separated groups representing each of the current day, days of a current week referenced to the current day, months, and days of the month.

10. The electronic calendar of claim 1 wherein the computer further executes the stored program to provide voice descriptions of the date functions of activated switches of the switch array selected from the group consisting of:
the day of the week, the month, and the day of the month.

11. The electronic calendar of claim 1 wherein the computer further executes the stored program to preface a played back audio message with the day of the week, the month, and the day of the month only when the day of the week, the month, and the day of the month are not provided in a played back description of immediately preceding activated switches.

12. The electronic calendar of claim 1 wherein the switch array further includes a to do button and wherein a computer system further executes the stored program to:
(i) link an audio message from the microphone to a to do list;
(ii) play back of the audio message regardless of the current date upon pressing of the to do button.

13. The electronic calendar of claim 1 wherein the computer system executes the stored program to link a first and second audio message to a single message date and to play back each of the audio messages linked to the message date upon invocation of the message date.

14. The electronic calendar of claim 1 wherein the computer system executes the stored program to save audio messages having message dates earlier than the current date for at least one month and to play back audio messages linked to a first message date within eleven months of the current date from the one month.

15. The electronic calendar of claim 1 further including a visual display indicating that there is at least one audio message linked to a message date equal to the current date.

16. An electronic calendar comprising:
a microphone accepting audio messages from an operator;
a date entry system accepting entry of a message date from an operator;
a computer connected to the microphone and date entry system to link the audio message and the message date;
a playback device communicating with the computer allowing playback of the audio message linked to the message date upon invocation of the message date; wherein the date entry system is a switch array providing:
(i) at least one switch invoking, when activated, a message date of the current day; and
(ii) at least 28 switches each invoking, when activated, a message date of predefined day of a month.

17. The electronic calendar of claim 16 wherein the at least twenty eight switches are arrayed in rows and columns with number captions increasing from left to right and top to bottom like a conventional calendar.

18. The electronic calendar of claim 16 wherein the switch array further provides at least seven switches invoking, when activated, a message date of a day of the week referenced to the current date.

19. The electronic calendar of claim 16 wherein the switch dedicated to the current day is encircled by the switches dedicated to the day of the week referenced to the current day.

20. An electronic calendar comprising:
(a) a housing supporting:
(i) a microphone accepting audio messages from an operator;
(ii) a switch array exposed at a front surface of the housing accepting a message date from an operator;
(iii) a speaker;
(iv) a computer connected to the microphone, switch array, and speaker, and executing a stored program to record audio messages linked to message dates and to playback those audio messages when the message date is invoked.
(v) a battery power supply for powering the computer system;
at least one magnet attached to a rear surface of the housing for supporting the housing against a vertical metal refrigerator door.

21. The electronic calendar of claim 21 wherein the switch array is a membrane switch providing a plurality of switches on continuous laminated membranes.

22. The electronic calendar of claim 21 wherein the computer system includes a micro controller having integrated analog to digital converter receiving an analog signal to the microphone and an integrated digital to analog converter providing an analog signal to the speaker.

23. The electronic calendar of claim 21 wherein the computer system further includes a non-volatile memory.

24. The electronic calendar of claim 21 wherein the computer system is programmed to enter a low power usage mode.

25. The electronic calendar of claim 21 wherein the computer system is programmed to exit a low power usage mode when any of a plurality of switches of the switch array is pressed.
